(19) United States
(12) Patent Application Publication
(10) Pub. No.: US 2023/0295020 A1
(43) Pub. Date: Sep. 21, 2023

(54) COMPOSITION FOR PURIFYING RESERVOIRS FROM CYANOBACTERIA AND GREEN ALGAE

(71) Applicant: LYSTERRA LLC, Moscow (RU)

(72) Inventor: Vladimir Vasil'evich ZAREV, Moscow (RU)

(21) Appl. No.: 17/999,858

(22) PCT Filed: Feb. 2, 2021
(86) PCT No.: PCT/IB2021/050812

§ 371 Date: Nov. 24, 2022

(30) Foreign Application Priority Data
Jun. 5, 2020 (RU) 2020118686

(51) Int. Cl. C02F 1/50; A01N 59/20; A01N 25/24

(52) U.S. Cl. CPC C02F 1/505; A01N 59/20; A01N 25/24; C02F 2303/04; C02F 2103/007

(57) ABSTRACT

The invention relates to the field of disinfection and purification of reservoirs from cyanobacteria and green algae. The composition for purifying water from cyanobacteria and green algae comprising copper sulphate powder and a binding agent, i.e. hydrophobizer, according to the invention comprises, as a binding agent, a hydrophobizer melt in the form of a high-melting triglyceride fraction to provide formation therebased of a superhydrophobic coating with a contact angle of 155-165°, by way of adding the hydrophobizer melt into copper sulphate powder heated to a temperature of 60-70°, with the following ratio of components, wt %: copper sulphate: 85-97 hydrophobizer melt in the form of high-melting triglyceride fractions—the remainder, followed by uniform mixing, incubating at a temperature of 65° C. for no more than 5 minutes, cooling to room temperature and grinding the resulting mixture to a dispersed state with a particle size of 50-250 microns.

The invention relates to the field of disinfection and purification of reservoirs from cyanobacteria and green algae.

Known is a composition for purifying a reservoir comprising copper sulphate and excipients (CN104556477 (A), cl. C02F 1/28, 2015).

Further known is a composite for the bactericidal treatment of reservoirs (CN107473344 (A), cl. C02F 43/36, 2017) comprising copper sulphate and excipients.

A common disadvantage of the known technical solutions are complexity, high costs and difficult process of the composition preparation, as well as insufficient efficiency of purifying vast reservoirs from cyanobacteria and green algae as a result of insufficient time of staying on the water surface until the active substance is completely dissolved.

Known is a technical solution comprising embodiments of buoyant, diffusing compositions for water purification from cyanobacteria and green algae (RU Patent No. 2687929, cl. C02F 103/04, 2019), one of the embodiments is the closest in terms of technical essence to the subject one, which comprises an active substance in the form of copper sulphate powder, a floating agent from saturated hydrocarbons, resinous materials, wax, natural or synthetic latex, and combinations thereof, for example, in the form of sawdust or rosin, etc., a binding agent, i.e. hydrophobizer, to form the coating of the active substance and swelling agent.

The process for preparing the composition includes the following steps:
thorough mixing of all components;
thereafter, feeding the resulting mixture to a 12 mm diameter granulator press, which produces beads with a thickness of approximately 7 mm and a mass of approximately 500 mg;
thereafter, incubating the beads in the oven at 115° C. for 3 minutes, removing from the oven, cooling, and grinding.

The advantage of the known technical solution is that all embodiments of the compositions are buoyant formulations of various bleaching agents that reduce the number of cyanobacteria populations in treated water.

However, the disadvantages of the known technical solution are:
using, as an active substance, of chlorine-containing agents that exhibit toxic properties when applying large amounts thereof as a result of a short dissolution period;
using a floating agent from saturated hydrocarbons, resinous materials, wax, natural or synthetic latex and combinations thereof, which, partially or completely, do not dissolve in water, polluting the reservoir after the active substance is no more active;
using a small amount of the active substance, which dissolves within 15 hours, as a result, water has to be treated several times, and which does not eliminate the trace toxicity of cyanobacteria and green algae;
complexity, which increases the cost of the composition.

The object of the invention is to provide a composition with an active substance content of at least 70%, which can stay on the water surface for a long time while maintaining solubility, with the least toxic properties and contamination.

The technical result of the claimed technical solution is to obtain a synergistic effect when cleaning vast reservoirs, due to the ability to stay on the water surface for a long time while maintaining solubility, the least toxic properties and contamination, as well as reducing the cost and expanding the range of compositions for water purification from cyanobacteria and green algae.

The technical result is achieved in that the composition for purifying water from cyanobacteria and green algae comprising copper sulphate powder and a binding agent, i.e. hydrophobizer, according to the invention comprises, as a binding agent, a hydrophobizer melt in the form of a high-melting triglyceride fraction to provide formation therebased of a superhydrophobic coating with a contact angle of 155-165°, by way of adding the hydrophobizer melt into copper sulphate powder heated to a temperature of 60-70°, with the following ratio of components, wt %:
copper sulphate: 85-97
hydrophobizer melt in the form of
high-melting triglyceride fractions—the remainder,
followed by uniform mixing, incubating at a temperature of 65° C. for no more than 5 minutes, cooling to room temperature and grinding the resulting mixture to a dispersed state with a particle size of 50-250 microns.

The novelty of the claimed composition is that, to achieve the technical result, a hydrophobizer melt in the form of a high-melting triglyceride fraction is used as a binding agent to form therebased a superhydrophobic coating with a contact angle of 155-165°, by way of crystallizing the surface under certain thermal conditions and qualitative states of the components that make up the composition.

Scientific, technical and patent literature does not provide a set of features to solve the problem that previously could not be solved by known technical solutions. The prior art provides no inventions that have features that coincide with the distinctive features of the subject composition, which fact indicates that the composition meets the patentability criterion of “inventive step”.

The industrial applicability of what is claimed is due to the fact that the preparation of the composition is technically feasible and it can be used for cleaning reservoirs from cyanobacteria and green algae.

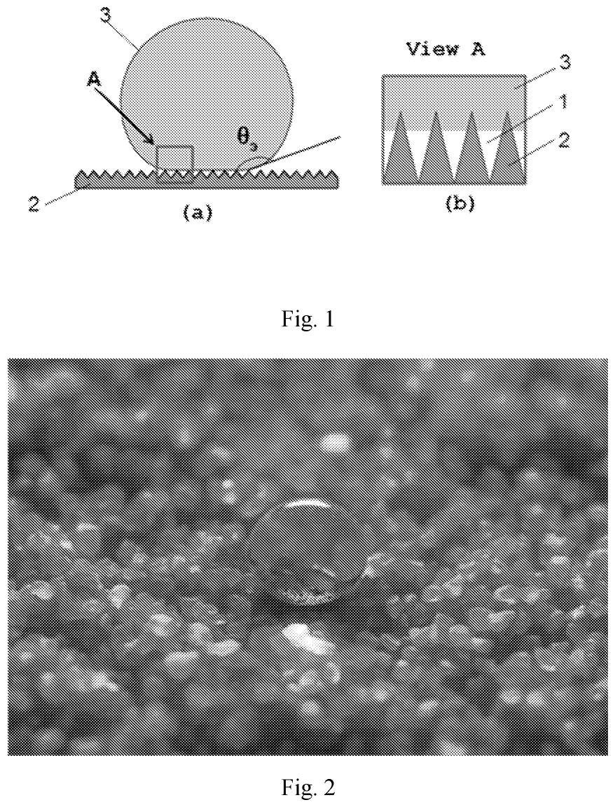

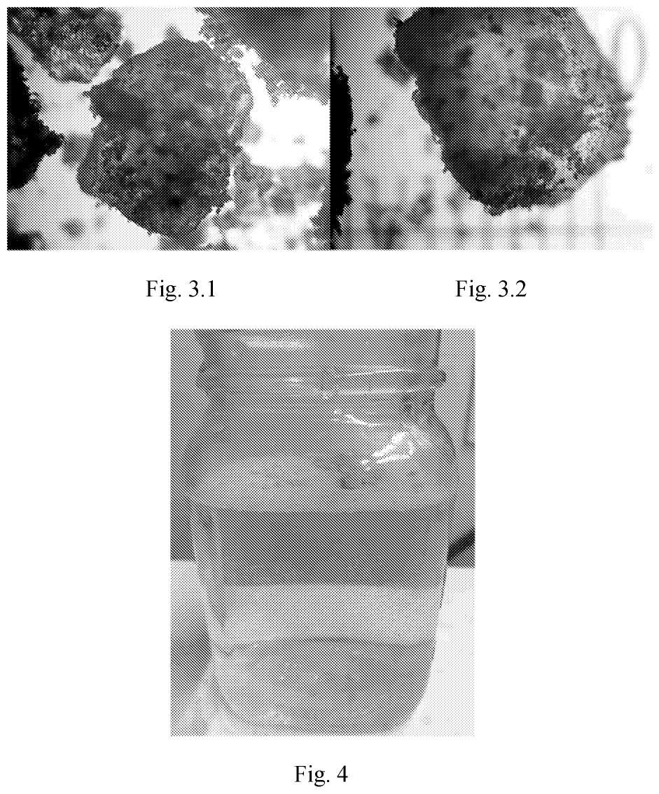

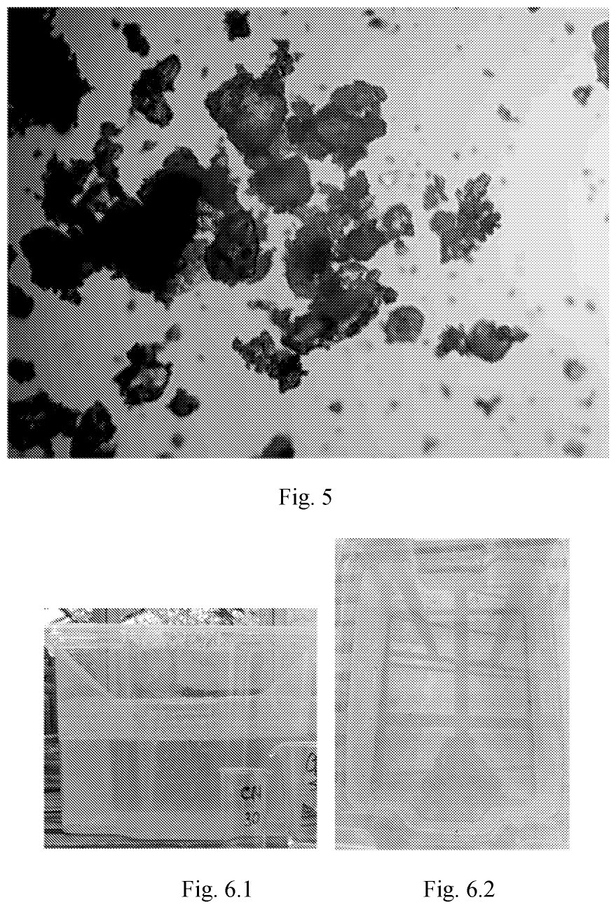

The essence of the invention is explained by drawings, where FIG. 1 (a) schematically shows the arrangement of copper sulphate powder treated by the hydrophobizer melt relative to fluid; (b) is a view A; FIG. 2 shows a drop of water on the surface of the copper sulphate powder treated by the hydrophobizer melt; FIGS. 3.1-3.2 show micrograph of particles of copper sulphate powder treated by the hydrophobizer melt (sample No. 4); FIG. 4 shows the testing of sample No. 4 in water; FIG. 5 shows a micrograph of crushed sample No. 4; FIGS. 6.1-6.2 show water treated by the composition on day 12 following treatment.

The working title of the composition for purifying reservoirs from cyanobacteria and green algae is “Vodagrad C”.

To obtain the composition, the following components have been used:
1. As the active substance (AS): copper sulphate (cupric sulfate, blue copperas), that is an inorganic compound, sulfuric acid copper salt with the chemical formula CuSO4. Non-volatile, odorless substance. A white powder, very hygroscopic substance in the anhydrous form. Transparent, non-hygroscopic crystals of various shades of blue in the crystalline hydrate form. Copper(II) sulfate is highly soluble in water. Blue pentahydrate CuSO₄·5H₂O, i.e. blue copperas, is crystallized from aqueous solutions.
   It has disinfectant, antiseptic, and astringent properties.
2. A hydrophobizer melt in the form of a high-melting triglyceride fraction was used as a binding agent. The hydrophobizer melt refers to the liquid state thereof at a temperature between the critical melting point and boiling point.

The choice of a hydrophobizer for the preparation of the composition was carried out taking into account the following criteria:
the selected hydrophobizer, or more specifically a hydrophobizer-based coating must have a contact angle of not less than 90°;
the hydrophobizer must have a melting point of at least 25° C., as at such a temperature many fats (triglycerides) in the solid state exhibit a good hydrophobization;
low cost of the hydrophobizer;
the hydrophobizer must be safe.

A research showed that these requirements are met by palm oil-based emulsifiers for the food industry produced by Palsgaard® (https://www.palsgaard.ru/sustainable-emulsifiers/emulsifier-overview/)

These emulsifiers are high-melting triglyceride fractions.

The composition for purifying reservoirs from cyanobacteria and green algae is prepared as follows.

When copper sulphate powder is introduced into water, it slowly or quickly, depending on the size of the particles, settles to the bottom, followed by dissolution thereof. To give the powder the ability to stay on the water surface, it is necessary to create superhydrophobic coatings characterized by contact angles of θₑ>150°. Thanks to such coatings, an air layer 1 is created between the surface of the powder 2 and the liquid 3, which fact leads to the material being pushed out to the surface of the water-air interface (FIG. 1), thanks to which fact a long remaining on the water surface is possible.

Two main conditions are to be fulfilled to create superhydrophobic coatings:
1. Create a dispersed (rough) surface structure, including the nanoscale level, by way of crystallizing the coating from the melt.
2. Hydrophobize the surface so that the value of contact angles is more than 90°.

To create a superhydrophobic coating, 85-97 g of copper sulphate (blue copperas) powder was taken per 100 g of the composition, uniformly heated to a temperature of 60-70° C., and the hydrophobizer melt (palm oil-based food emulsifier) was taken in an amount—the remainder up to 100 g at a temperature not higher than 65° C., which corresponds to an intermediate value between the critical melting point and boiling point, and added by evenly spraying the heated powder on the surface using a spraying device, while simultaneously uniformly mixing and incubating same for no more than 5 minutes to crystallize the surface of the powder at a temperature not lower than the melting point (55° C.) of the palm oil-based food emulsifier (hydrophobizer), followed by cooling same to room temperature. The resulting mixture was then ground to a dispersed state with a particle size of 50-250 microns. The temperature mode of heating of the copper sulphate powder (60-70° C.), hydrophobizer melt (65° C.), as well as stirring and aging for not more than 5 min at a temperature below the melting point (55° C.) of the palm oil-based food emulsifier is conditioned by the fact that such temperature combination provides a uniform crystallization of the surface of the active agent powder.

The composition was prepared using the following equipment: a vertical mechanical agitator (https://www.ika.com/ru/Products-Lab-Eq/Overhead-Stirrers-Agitator-Blender-Lab-mixer-csp-187/), induction stove, stainless tank (10 L capacity), temperature sensor. A hammer crusher was selected to be used as a dispersing device (https://infelko.ru/drobilki/drobilki-molotkovye-molot-200-400.html). The grinding parameters (motor power: 1.5 kW, feed rate of the material for crushing: no more than 200 g/min, internal grids with a pore size of 2 mm) were selected so as to obtain, in output, a powder with a particle size ranging from 50 to 250 microns. The composition obtained in this manner had the superhydrophobicity effect characterized by the value of the water contact angle of 155-165° as determined by a drop sliding over the resulting coating (FIG. 2). If water drops roll on the surface of the copper sulphate powder coating and do not absorb therein, the coating formation process is considered uniform.

To determine the optimal quantity of components to be included in the composition, 5 samples were created with different contents of the active substance and hydrophobizer melt, and experiments were conducted to determine the water contact angle of the superhydrophobic coating and the time of composition dissolution by way of testing which was carried out by simply introducing the composition into water.

The results are shown in Table 1.

TABLE 1
Results of experiments to determine the water contact angle of
the superhydrophobic coating and composition dissolution time

| | Components | | Contact | |
|---|---|---|---|---|
| Sample | Copper sulphate, | Hydrophobizer | angle, | Dissolution |
| No. | wt % | melt, wt % | θ, ° | period, days |
| 1 | 80 | Remainder | 145 | 3 |
| 2 | 85 | Remainder | 153 | 3.5 |
| 3 | 90 | Remainder | 157 | 5 |
| 4 | 97 | Remainder | 163 | 7 |
| 5 | 99 | Remainder | 175 | — |

According to the table data, the longest periods of dissolution and remaining on the surface were observed in sample No. 4, with a 97% content of copper sulphate and 3% content of hydrophobizer melt. Since sample No. 4 was the most effective, only this sample is shown on the graphic material. FIG. 4 shows that a small fraction of the material in sample No. 4, which apparently has a large particle size, settled to the bottom as a result of gravity prevailing over the Archimede's force. Furthermore, the solubility in water was not very high, and the sample was completely dissolved within 7 days.

Further, microphotographs of the particles of sample No. 4 were analyzed to show that a discrete coating has been formed, the thickness of which is from 100 to 200 nm (FIGS. 3.1-3.2).

After analyzing the dispersion of the initial blue copperas and sample No. 4, it was determined that the particle size was in the range of 200 to 3000 microns. Such sizing, according to the authors, negatively affects the buoyancy of the material and solubility thereof, and therefore, sample No. 4 was crushed to a degree of dispersion in the range of 50 to 250 microns, such particle sizing was the most effective. The particle size was controlled by the Klin grindometer (http://www.defectoscop.ru/product84.html). The optical image of the crushed sample No. 4 is shown in FIG. 5.

To prove the efficiency of the subject composition, pilot tests were conducted.

The tests were conducted at the premises of the Federal State Funded Research Institution “All-Russian Research Institute of Biological Plant Protection” (Krasnodar), by the laboratory of genetic collection of tomato.

According to the work procedure, water samples from Lake Abrau were taken with a plankton grid (cloth No. 78) during the blue-green algae (cyanobacteria and green algae) blooming of water. To collect the biomass, the upper 1-meter layer was filtered off. In two weeks, following cultivation, water containing blue-green algae was poured into 20-liter cuvettes and the composition was added at the rate of consumption, according to Table 2 for assessing the impact on cyanobacteria.

The experiment lasted from 4 to 8 weeks.

After applying the composition, the algae cells formed colonies on the surface and deposited after a while. The water itself took on a bright blue color, which faded as the product deposited. It was further noted that, when high doses were introduced, a portion of the product sediments, and another portion remains on the surface. The color of the algae changed from bright green to gray-brown. In 12 days following the introduction of the composition at the highest amount (20 kg/ha), the formation of new colonies on the bottom and walls of the vessel was not observed, the water became clear, but had a yellowish tinge (FIGS. 6.1-6.2).

TABLE 2
Doses of the composition in model reservoirs using the biological
material from Lake Abrau.

| | Amount of composition | Formation of new cyanobacteria |
|---|---|---|
| | on reservoir surface, | colonies, 12 days following |
| Variant | kg/ha | treatment |
| 1 | 2.25 | Vessel's bottom is entirely covered |
| | | with cyanobacteria colonies |
| 2 | 4.25 | Vessel's bottom is partially |
| | | (70%) covered with cyanobacteria |
| | | colonies |
| 3 | 6.25 | Vessel's bottom is partially |
| | | (40%) covered with cyanobacteria |
| | | colonies |
| 4 | 10 | Vessel's bottom is partially |
| | | (20%) covered with cyanobacteria |
| | | colonies |
| 5 | 20 | Vessel's bottom is clean |

To assess the toxicity of the treated water, a garden cress (Lepidium sativum L.) bioassay was employed.

The bioassay was conducted in Petri dishes in three replicates for each sample. Filter paper discs were placed on the bottom of a Petri dish. In each dish, 30 garden cress seeds were placed on the surface of the substrate. The same filter paper discs were placed on top. The filter paper in all the dishes was moistened with water from the test samples in accordance with the variants of the experiment. One of the samples with distilled water is a control which was used in a comparative analysis with the phytotest indicators of other samples in question. Germination of seeds was carried out in a thermostatic cabinet at a temperature of 20-25° C. for 7-10 days. At the end of the experiment, the phytotest parameters were measured: seedling length, average dry weight, germinability, germinative power. The results are shown in Table 3.

TABLE 3
Measured parameters of Lepidium sativum L. formed under the
influence of the samples in question from Lake Abrau.

| | Phytotest parameters (after the second introduction) | | | |
|---|---|---|---|---|
| Experiment | Seedling length | Dry weight | Germinability | Germination |
| variant | (mm) | (mg) | on day 5(%) | power(%) |
| 1 | 112 | 1.22 | 90.7 | 80.5 |
| 2 | 125 | 1.38 | 93.0 | 82.5 |
| 3 | 143 | 1.54 | 95.3 | 88.8 |
| 4 | 152 | 1.60 | 95.5 | 92.0 |
| 5 | 162 | 1.64 | 96.2 | 92.0 |
| control | 164 | 1.76 | 96.6 | 94.2 |

The conducted studies show an acute samples' toxicity remaining after cyanobacteria in variants with a minimum dose of the composition and show a decrease in the samples' toxic properties remaining after cyanobacteria with an increase in the dose of the composition.

To confirm the compliance of the claimed technical solution with patentability criteria, comparative analyses were conducted to determine the novelty of features relative to the prototype (Table 4) and essential features of the composition that allow achieving the technical result (Table 5).

TABLE 4
Examination of features for novelty.

| Prototype | Subject composition |
|---|---|
| Water disinfection agents: chlorine- | Copper sulphate powder |
| containing agents and copper | |
| sulphate powder | |
| Floating (buoyant) agent consisting | Not present |
| of saturated hydrocarbons, resinous | |
| materials, wax, sawdust, natural or | |
| synthetic latex, and combinations | |
| thereof, which are partially or | |
| completely insoluble in water. | |
| The binding agent is hydrophobizer | Hydrophobizer melt in the form |
| glyceryl stearate that does not | of a high-melting triglyceride |
| provide formation therebased of a | fraction to ensure the formation |
| superhydrophobic coating | therebased of a superhydrophobic |
| | coating |
| Swelling agent | Not present |

TABLE 5
Examination of essential features of the subject technical solution.

| | Novel properties | |
|---|---|---|
| Essential features of | acquired as a result | Achieved positive |
| the subject solution | of using the features | effect |
| Hydrophobizer melt in | Forming a dispersed | 1. Obtaining a |
| the form of a high- | (rough) surface | synergistic effect due |
| melting triglyceride | structure, including | to a long period of |
| fraction | the nanoscale level, | being on the water |
| Adding hydrophobizer | by crystallizing | surface with the |
| melt in copper sulphate | the coating from the | preservation of |
| powder heated to a | melt and | solubility and the |
| temperature of 60-70º | hydrophobizing | least toxic properties |
| Ratio of components, | the surface so as | and contamination |
| wt %: | to ensure the | of a reservoir. |
| copper sulphate: 85-97 | formation of a | 2. Reducing costs 3. |
| hydrophobizer melt: | superhydrophobic | Expanding the |
| remainder | coating with a | range of |
| | contact angle of | compositions for |
| | 155-165º. | water purification |

Thus, the obtained results of pilot tests (Tables 1, 2, 3), as well as the examination of features (Tables 4, 5) allow to conclude that the subject composition showed high efficiency in purifying reservoirs from cyanobacteria and green algae.

What is claimed is:

1. A composition for purifying water from cyanobacteria and green algae comprising copper sulphate powder and a binding agent, i.e. hydrophobizer, characterized in that it comprises, as a binding agent, a hydrophobizer melt in the form of a high-melting triglyceride fraction to provide formation therebased of a super-hydrophobic coating with a contact angle of 155-165°, by way of adding the hydrophobizer melt into copper sulphate powder heated to a temperature of 60-70°, with the following ratio of components, wt %:
copper sulphate: 85-97
hydrophobizer melt in the form of
high-melting triglyceride fractions—the remainder,
followed by uniform mixing, incubating at a temperature of 65° C. for no more than 5 minutes, cooling to room temperature and grinding the resulting mixture to a dispersed state with a particle size of 50-250 microns.
